(19) United States
(12) Patent Application Publication
(10) Pub. No.: US 2026/0073804 A1
(43) Pub. Date: Mar. 12, 2026

(54) SYSTEM

(71) Applicant: SoftBank Group Corp., Tokyo (JP)

(72) Inventor: Hironori TSUCHIDA, Tokyo (JP)

(21) Appl. No.: 19/314,907

(22) Filed: Aug. 29, 2025

(30) Foreign Application Priority Data
Sep. 10, 2024 (JP) 2024-156384

(51) Int. Cl. G09B 7/00; G06F 21/32; G06V 20/52; G06V 40/16; G06V 40/20

(52) U.S. Cl. CPC G09B 7/00; G06F 21/32; G06V 20/52; G06V 40/172; G06V 40/20

(57) ABSTRACT

The system according to the embodiment comprises an authentication unit, a retrieval unit, a monitoring unit, an assist unit, a selection unit, a temperature control unit, a blocking unit, a communication unit, and a display unit. The authentication unit recognizes the user. The retrieval unit retrieves the learning data of the user recognized by the authentication unit. The monitoring unit monitors the user's movements. The assist unit provides hints when the movement monitored by the monitoring unit stops. The selection unit selects questions previously answered incorrectly and presents them again. The temperature control unit performs automatic temperature adjustment by AI. The blocking unit blocks external radio waves. The communication unit provides Wi-Fi. The display unit displays information on a monitor.

### CROSS-REFERENCE TO RELATED APPLICATION

The present application claims priority to and incorporates by reference the entire contents of Japanese Patent Application No. 2024-156384 filed in Japan on Sep. 10, 2024.

### BACKGROUND OF THE INVENTION

### 1. Field of the Invention

The technology of this disclosure relates to the system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In the prior art, there is a lack of multifunctional systems for optimizing the learning environment, leaving room for improvement in learning efficiency.

### SUMMARY OF THE INVENTION

The system according to the embodiment comprises an authentication unit, a retrieval unit, a monitoring unit, an assist unit, a selection unit, a temperature control unit, a blocking unit, a communication unit, and a display unit. The authentication unit recognizes the user. The retrieval unit retrieves the learning data of the user recognized by the authentication unit. The monitoring unit monitors the user's movements. The assist unit provides hints when the movement monitored by the monitoring unit stops. The selection unit selects questions previously answered incorrectly and presents them again. The temperature control unit performs automatic temperature adjustment by AI. The blocking unit blocks external radio waves. The communication unit provides Wi-Fi. The display unit displays information on a monitor.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B.

Moreover, when expressing three or more items connected by “and/or,” the same concept as “A and/or B” applies.

### First Embodiment

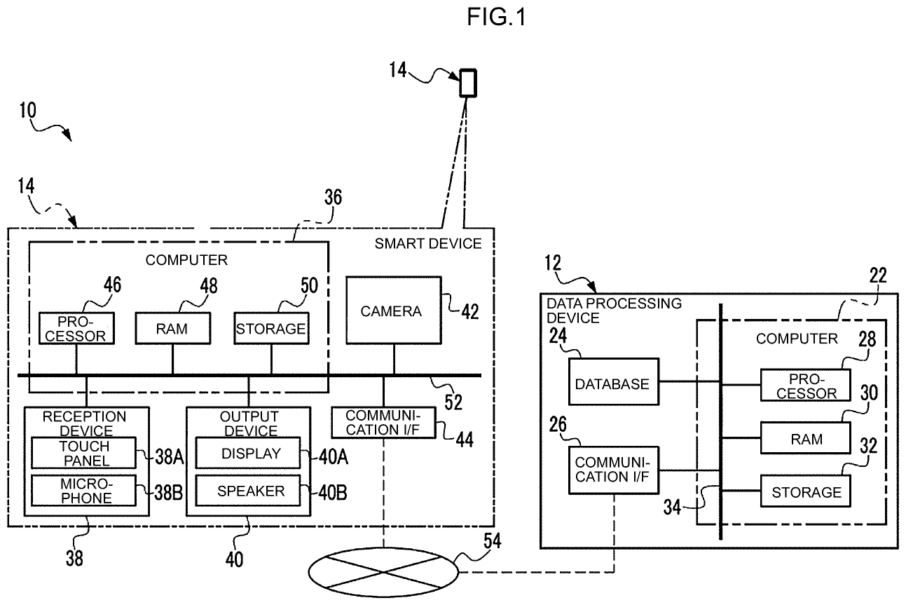

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

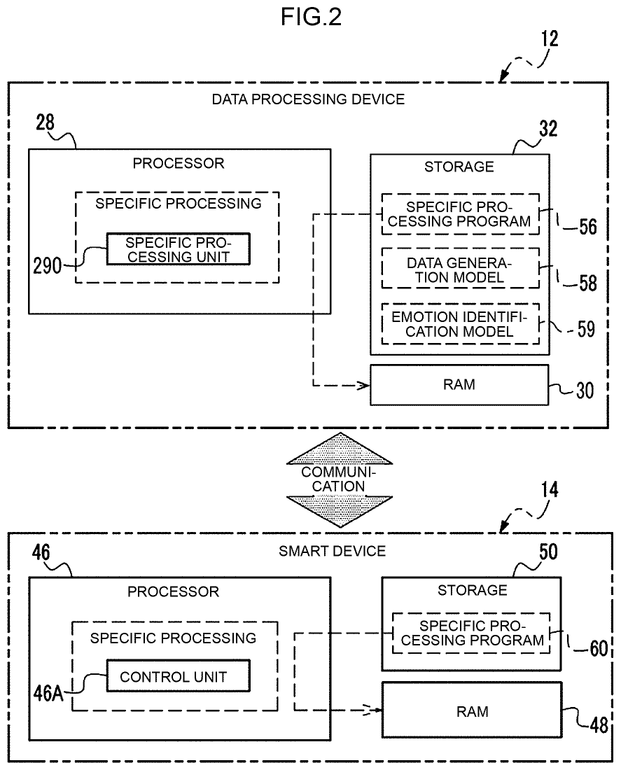

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The learning support system according to the embodiment of the present invention is a system that provides an environment in which a user can concentrate and learn intensively in a short period of time. This learning support system is equipped with facial recognition, AI camera, AI-based automatic temperature control, radio wave blocking box, Wi-Fi, and monitor in a phone booth-sized box, similar to a phone booth, to create an environment where users can concentrate and learn intensively in a short time. First, when the user enters the phone booth, the facial recognition system recognizes the user and retrieves individual learning data. Next, the AI camera monitors the user's movements and tracks the learning progress in real time. For example, if the user's movement stops in response to a question, the generative AI provides a hint after a few seconds. It also has a function to select questions previously answered incorrectly and present them again. Furthermore, it is equipped with an AI-based automatic temperature control function to maintain a comfortable learning environment for the user. The radio wave blocking box prevents external interference and enhances concentration. With Wi-Fi and a monitor, it is also compatible with online learning and remote meetings. With this system, users can efficiently proceed with learning in a short period of time and maintain high productivity even in today's society where deadlines are pressing. For example, when the user enters the phone booth, the facial recognition system recognizes the user and retrieves individual learning data. Next, the AI camera monitors the user's movements and tracks the learning progress in real time. For example, if the user's movement stops in response to a question, the generative AI provides a hint after a few seconds. It also has a function to select questions previously answered incorrectly and present them again. Furthermore, it is equipped with an AI-based automatic temperature control function to maintain a comfortable learning environment for the user. The radio wave blocking box prevents external interference and enhances concentration. With Wi-Fi and a monitor, it is also compatible with online learning and remote meetings. With this system, users can efficiently proceed with learning in a short period of time and maintain high productivity even in today's society where deadlines are pressing. Thus, the learning support system can optimize the user's learning environment and support efficient learning.

The learning support system according to the embodiment comprises an authentication unit, a retrieval unit, a monitoring unit, an assist unit, a selection unit, a temperature control unit, a blocking unit, a communication unit, and a display unit. The authentication unit recognizes the user. For example, the user can be recognized by methods such as facial recognition, fingerprint recognition, or voice recognition. The retrieval unit retrieves the learning data of the user recognized by the authentication unit. For example, it can retrieve learning data such as text data, image data, or audio data. The monitoring unit monitors the user's movements. For example, the user's movements can be monitored by methods such as motion detection using a camera or motion detection using sensors. The assist unit provides hints when the movement monitored by the monitoring unit stops. For example, hints can be provided by methods such as text messages, voice messages, or visual presentation. The selection unit selects questions previously answered incorrectly and presents them again. For example, questions previously answered incorrectly can be selected based on criteria such as the number of mistakes or the content of the mistakes. The temperature control unit performs automatic temperature adjustment by AI. For example, automatic temperature adjustment can be performed by methods such as using temperature sensors or types of learning algorithms. The blocking unit blocks external radio waves. For example, external radio waves can be blocked by methods such as using radio wave blocking materials or shielding technology. The communication unit provides Wi-Fi. For example, Wi-Fi can be provided by methods such as types of routers or communication protocols. The display unit displays information on a monitor. For example, information can be displayed by methods such as types of displays or display formats. Thus, the learning support system according to the embodiment can optimize the user's learning environment and support efficient learning.

The monitoring unit can monitor the user's movements in real time. The monitoring unit, for example, monitors the user's movements in real time using a camera. For example, the monitoring unit captures the user's movements with a high-resolution camera and analyzes the movements in real time. The monitoring unit can also monitor the user's movements in real time using sensors. For example, the monitoring unit detects the user's movements with a motion sensor and analyzes the movements in real time. The monitoring unit can also monitor the user's movements in real time using AI. For example, the monitoring unit analyzes the user's movements using an AI camera and monitors the movements in real time. Thus, by monitoring the user's movements in real time, the monitoring unit can accurately grasp the progress of learning.

The assist unit can provide a hint after a certain period of time when the user's movement stops. The assist unit, for example, provides a hint a few seconds after the user's movement stops. For example, the assist unit provides a hint via a text message a few seconds after the user's movement stops in response to a question. The assist unit can also provide a hint via a voice message when the user's movement stops. For example, the assist unit provides a hint via a voice message a few seconds after the user's movement stops in response to a question. The assist unit can also provide a hint via visual presentation when the user's movement stops. For example, the assist unit provides a hint via visual presentation a few seconds after the user's movement stops in response to a question. Thus, the assist unit can provide appropriate hints at the right timing when the user is stuck on a question.

The selection unit can select questions previously answered incorrectly and present them again. The selection unit, for example, selects questions previously answered incorrectly and presents them again. For example, the selection unit extracts questions previously answered incorrectly by the user from a database and presents them again. The selection unit can also select questions based on the number of times they were answered incorrectly. For example, the selection unit selects questions to be presented again based on the number of times the user answered them incorrectly in the past. The selection unit can also select questions based on the content of the mistakes. For example, the selection unit selects questions to be presented again based on the content of the user's past mistakes. Thus, the selection unit can provide effective review based on the user's past learning history.

The temperature control unit can perform automatic temperature adjustment by AI. The temperature control unit, for example, performs automatic temperature adjustment using AI. For example, the temperature control unit measures the room temperature using a temperature sensor, and the AI calculates the optimal temperature and automatically adjusts it. The temperature control unit can also measure the user's body temperature and the AI calculates the optimal room temperature and automatically adjusts it. For example, the temperature control unit measures the user's body temperature with a sensor, and the AI calculates the optimal room temperature and automatically adjusts it. The temperature control unit can also monitor the user's movements and the AI calculates the optimal temperature and automatically adjusts it. For example, the temperature control unit monitors the user's movements with a camera, and the AI calculates the optimal temperature and automatically adjusts it. Thus, the temperature control unit can maintain a comfortable learning environment for the user.

The blocking unit can block external radio waves. The blocking unit, for example, blocks external radio waves using radio wave blocking materials. For example, the blocking unit blocks external radio waves using radio wave blocking materials. The blocking unit can also block external radio waves using shielding technology. For example, the blocking unit blocks external radio waves using shielding technology. The blocking unit can also block external radio waves using radio wave blocking films. For example, the blocking unit blocks external radio waves using radio wave blocking films. Thus, the blocking unit can prevent external interference and enhance concentration.

The communication unit can provide Wi-Fi. The communication unit, for example, provides Wi-Fi using a router. For example, the communication unit provides Wi-Fi using a router. The communication unit can also provide Wi-Fi using communication protocols. For example, the communication unit provides Wi-Fi using communication protocols. The communication unit can also provide Wi-Fi using Wi-Fi access points. For example, the communication unit provides Wi-Fi using Wi-Fi access points. Thus, the communication unit enables online learning and remote meetings.

The display unit can display information on a monitor. The display unit, for example, displays information using a display. For example, the display unit displays information using a display. The display unit can also display information using display formats. For example, the display unit displays information using display formats. The display unit can also display information using a projector. For example, the display unit displays information using a projector. Thus, the display unit allows users to visually check learning content and meeting materials.

The authentication unit can refer to the user's past authentication history at the time of authentication to improve authentication accuracy. The authentication unit, for example, refers to the user's past authentication history at the time of authentication to improve authentication accuracy. For example, the authentication unit preferentially uses authentication methods (such as facial recognition or fingerprint recognition) that the user has used in the past. The authentication unit can also predict the time required for authentication from the user's past authentication history and propose the optimal authentication method. The authentication unit can also analyze the user's past authentication history to find patterns for improving authentication accuracy. Thus, the authentication unit can improve authentication accuracy based on past authentication history.

The authentication unit can additionally acquire the user's biometric information at the time of authentication to enhance the reliability of authentication. The authentication unit, for example, additionally acquires the user's biometric information (such as heart rate or body temperature) at the time of authentication to enhance the reliability of authentication. For example, the authentication unit measures the user's heart rate and checks whether it is within the normal range. The authentication unit can also measure the user's body temperature and check for abnormalities. The authentication unit can also comprehensively analyze the user's biometric information to enhance the reliability of authentication. Thus, the authentication unit can improve the reliability of authentication based on biometric information.

The authentication unit can customize the authentication process by taking into account the user's geographic location information at the time of authentication. The authentication unit, for example, customizes the authentication process by taking into account the user's geographic location information at the time of authentication. For example, the authentication unit provides a simplified authentication process when the user is at home. The authentication unit can also provide a detailed authentication process when the user is in a public place. The authentication unit can also provide an authentication method appropriate for the location when the user is in a specific place. Thus, the authentication unit can optimize the authentication process based on geographic location information.

The authentication unit can analyze the user's social media activity at the time of authentication to improve the reliability of authentication. The authentication unit, for example, analyzes the user's social media activity at the time of authentication to improve the reliability of authentication. For example, the authentication unit grasps the user's current situation from social media activity and adjusts the authentication process. The authentication unit can also analyze the user's social media activity to find patterns for improving the reliability of authentication. The authentication unit can also select an authentication method based on the user's social media activity. Thus, the authentication unit can improve the reliability of authentication based on social media activity.

The retrieval unit can refer to the user's past learning history at the time of retrieval to select optimal learning data. The retrieval unit, for example, refers to the user's past learning history at the time of retrieval to select optimal learning data. For example, the retrieval unit preferentially retrieves questions previously answered incorrectly by the user. The retrieval unit can also select the most effective learning data from the user's past learning history. The retrieval unit can also analyze the user's past learning history to propose optimal learning data. Thus, the retrieval unit can provide optimal learning data based on past learning history.

The retrieval unit can customize data based on the user's current learning progress at the time of retrieval. The retrieval unit, for example, customizes data based on the user's current learning progress at the time of retrieval. For example, the retrieval unit proposes the next learning data to be studied according to the user's current learning progress. The retrieval unit can also grasp the user's learning progress in real time and provide optimal learning data. The retrieval unit can also analyze the user's learning progress to select effective learning data. Thus, the retrieval unit can provide optimal learning data based on the current learning progress.

The retrieval unit can prioritize the retrieval of highly relevant learning data by taking into account the user's geographic location information at the time of retrieval. The retrieval unit, for example, prioritizes the retrieval of highly relevant learning data by taking into account the user's geographic location information at the time of retrieval. For example, the retrieval unit prioritizes the retrieval of learning data related to the location when the user is in a specific place. The retrieval unit can also propose optimal learning data based on the user's geographic location information. The retrieval unit can also provide highly relevant learning data by taking into account the user's geographic location information. Thus, the retrieval unit can provide highly relevant learning data based on geographic location information.

The retrieval unit can analyze the user's social media activity at the time of retrieval to retrieve relevant learning data. The retrieval unit, for example, analyzes the user's social media activity at the time of retrieval to retrieve relevant learning data. For example, the retrieval unit grasps the user's current interests from social media activity and provides relevant learning data. The retrieval unit can also analyze the user's social media activity to propose optimal learning data. The retrieval unit can also retrieve highly relevant learning data based on the user's social media activity. Thus, the retrieval unit can provide highly relevant learning data based on social media activity.

The monitoring unit can refer to the user's past behavior patterns at the time of monitoring to improve monitoring accuracy. The monitoring unit, for example, refers to the user's past behavior patterns at the time of monitoring to improve monitoring accuracy. For example, the monitoring unit proposes optimal monitoring methods based on the user's past behavior patterns. The monitoring unit can also analyze the user's past behavior patterns to find patterns for improving monitoring accuracy. The monitoring unit can also adjust the timing of monitoring by referring to the user's past behavior patterns. Thus, the monitoring unit can improve monitoring accuracy based on past behavior patterns.

The monitoring unit can additionally acquire the user's biometric information at the time of monitoring to enhance the reliability of monitoring. The monitoring unit, for example, additionally acquires the user's biometric information (such as heart rate or body temperature) at the time of monitoring to enhance the reliability of monitoring. For example, the monitoring unit measures the user's heart rate and checks whether it is within the normal range. The monitoring unit can also measure the user's body temperature and check for abnormalities. The monitoring unit can also comprehensively analyze the user's biometric information to enhance the reliability of monitoring. Thus, the monitoring unit can improve the reliability of monitoring based on biometric information.

The monitoring unit can customize the monitoring range by taking into account the user's geographic location information at the time of monitoring. The monitoring unit, for example, customizes the monitoring range by taking into account the user's geographic location information at the time of monitoring. For example, the monitoring unit sets the monitoring range according to the location when the user is in a specific place. The monitoring unit can also propose the optimal monitoring range based on the user's geographic location information. The monitoring unit can also adjust the monitoring range by taking into account the user's geographic location information. Thus, the monitoring unit can provide the optimal monitoring range based on geographic location information.

The monitoring unit can analyze the user's social media activity at the time of monitoring to improve monitoring accuracy. The monitoring unit, for example, analyzes the user's social media activity at the time of monitoring to improve monitoring accuracy. For example, the monitoring unit grasps the user's current situation from social media activity and improves monitoring accuracy. The monitoring unit can also analyze the user's social media activity to propose optimal monitoring methods. The monitoring unit can also adjust the monitoring range based on the user's social media activity. Thus, the monitoring unit can improve monitoring accuracy based on social media activity.

The assist unit can refer to the user's past learning history at the time of assistance to provide optimal hints. The assist unit, for example, refers to the user's past learning history at the time of assistance to provide optimal hints. For example, the assist unit provides relevant hints for questions previously answered incorrectly by the user. The assist unit can also select the most effective hints from the user's past learning history. The assist unit can also analyze the user's past learning history to propose optimal hints. Thus, the assist unit can provide optimal hints based on past learning history.

The assist unit can customize hints based on the user's current learning progress at the time of assistance. The assist unit, for example, customizes hints based on the user's current learning progress at the time of assistance. For example, the assist unit provides hints related to the next content to be learned according to the user's current learning progress. The assist unit can also grasp the user's learning progress in real time and provide optimal hints. The assist unit can also analyze the user's learning progress to select effective hints. Thus, the assist unit can provide optimal hints based on the current learning progress.

The assist unit can prioritize the provision of highly relevant hints by taking into account the user's geographic location information at the time of assistance. The assist unit, for example, prioritizes the provision of highly relevant hints by taking into account the user's geographic location information at the time of assistance. For example, the assist unit prioritizes the provision of hints related to the location when the user is in a specific place. The assist unit can also propose optimal hints based on the user's geographic location information. The assist unit can also provide highly relevant hints by taking into account the user's geographic location information. Thus, the assist unit can provide highly relevant hints based on geographic location information.

The assist unit can analyze the user's social media activity at the time of assistance to provide relevant hints. The assist unit, for example, analyzes the user's social media activity at the time of assistance to provide relevant hints. For example, the assist unit grasps the user's current interests from social media activity and provides relevant hints. The assist unit can also analyze the user's social media activity to propose optimal hints. The assist unit can also provide highly relevant hints based on the user's social media activity. Thus, the assist unit can provide highly relevant hints based on social media activity.

The selection unit can refer to the user's past learning history at the time of selection to select optimal questions. The selection unit, for example, refers to the user's past learning history at the time of selection to select optimal questions. For example, the selection unit preferentially selects questions previously answered incorrectly by the user. The selection unit can also select the most effective questions from the user's past learning history. The selection unit can also analyze the user's past learning history to propose optimal questions. Thus, the selection unit can provide optimal questions based on past learning history.

The selection unit can customize questions based on the user's current learning progress at the time of selection. The selection unit, for example, customizes questions based on the user's current learning progress at the time of selection. For example, the selection unit selects the next questions to be learned according to the user's current learning progress. The selection unit can also grasp the user's learning progress in real time and provide optimal questions. The selection unit can also analyze the user's learning progress to select effective questions. Thus, the selection unit can provide optimal questions based on the current learning progress.

The selection unit can prioritize the selection of highly relevant questions by taking into account the user's geographic location information at the time of selection. The selection unit, for example, prioritizes the selection of highly relevant questions by taking into account the user's geographic location information at the time of selection. For example, the selection unit prioritizes the selection of questions related to the location when the user is in a specific place. The selection unit can also propose optimal questions based on the user's geographic location information. The selection unit can also provide highly relevant questions by taking into account the user's geographic location information. Thus, the selection unit can provide highly relevant questions based on geographic location information.

The selection unit can analyze the user's social media activity at the time of selection to select relevant questions. The selection unit, for example, analyzes the user's social media activity at the time of selection to select relevant questions. For example, the selection unit grasps the user's current interests from social media activity and provides relevant questions. The selection unit can also analyze the user's social media activity to propose optimal questions. The selection unit can also select highly relevant questions based on the user's social media activity. Thus, the selection unit can provide highly relevant questions based on social media activity.

The temperature control unit can refer to the user's past temperature setting history at the time of temperature adjustment to set the optimal temperature. The temperature control unit, for example, refers to the user's past temperature setting history at the time of temperature adjustment to set the optimal temperature. For example, the temperature control unit proposes the optimal temperature based on the temperatures previously set by the user. The temperature control unit can also select the most comfortable temperature from the user's past temperature setting history. The temperature control unit can also analyze the user's past temperature setting history to set the optimal temperature. Thus, the temperature control unit can provide the optimal temperature based on past temperature setting history.

The temperature control unit can additionally acquire the user's biometric information at the time of temperature adjustment to enhance the reliability of temperature control. The temperature control unit, for example, additionally acquires the user's biometric information (such as heart rate or body temperature) at the time of temperature adjustment to enhance the reliability of temperature control. For example, the temperature control unit measures the user's heart rate and checks whether it is within the normal range. The temperature control unit can also measure the user's body temperature and check for abnormalities. The temperature control unit can also comprehensively analyze the user's biometric information to set the optimal temperature. Thus, the temperature control unit can provide the optimal temperature based on biometric information.

The temperature control unit can set the optimal temperature by taking into account the user's geographic location information at the time of temperature adjustment. The temperature control unit, for example, sets the optimal temperature by taking into account the user's geographic location information at the time of temperature adjustment. For example, the temperature control unit sets the optimal temperature according to the location when the user is in a specific place. The temperature control unit can also propose the optimal temperature based on the user's geographic location information. The temperature control unit can also set the optimal temperature by taking into account the user's geographic location information. Thus, the temperature control unit can provide the optimal temperature based on geographic location information.

The temperature control unit can analyze the user's social media activity at the time of temperature adjustment to provide relevant temperature settings. The temperature control unit, for example, analyzes the user's social media activity at the time of temperature adjustment to provide relevant temperature settings. For example, the temperature control unit grasps the user's current situation from social media activity and sets the optimal temperature. The temperature control unit can also analyze the user's social media activity to propose the optimal temperature. The temperature control unit can also provide highly relevant temperature settings based on the user's social media activity. Thus, the temperature control unit can provide the optimal temperature based on social media activity.

The blocking unit can refer to the user's past blocking history at the time of blocking to select the optimal blocking method. The blocking unit, for example, refers to the user's past blocking history at the time of blocking to select the optimal blocking method. For example, the blocking unit preferentially uses blocking methods previously used by the user. The blocking unit can also select the most effective blocking method from the user's past blocking history. The blocking unit can also analyze the user's past blocking history to propose the optimal blocking method. Thus, the blocking unit can provide the optimal blocking method based on past blocking history.

The blocking unit can select the optimal blocking method by taking into account the user's geographic location information at the time of blocking. The blocking unit, for example, selects the optimal blocking method by taking into account the user's geographic location information at the time of blocking. For example, the blocking unit selects the optimal blocking method according to the location when the user is in a specific place. The blocking unit can also propose the optimal blocking method based on the user's geographic location information. The blocking unit can also provide the optimal blocking method by taking into account the user's geographic location information. Thus, the blocking unit can provide the optimal blocking method based on geographic location information.

The communication unit can refer to the user's past communication history at the time of communication to select the optimal connection method. The communication unit, for example, refers to the user's past communication history at the time of communication to select the optimal connection method. For example, the communication unit preferentially uses connection methods previously used by the user. The communication unit can also select the most effective connection method from the user's past communication history. The communication unit can also analyze the user's past communication history to propose the optimal connection method. Thus, the communication unit can provide the optimal connection method based on past communication history.

The communication unit can select the optimal connection method by taking into account the user's geographic location information at the time of communication. The communication unit, for example, selects the optimal connection method by taking into account the user's geographic location information at the time of communication. For example, the communication unit selects the optimal connection method according to the location when the user is in a specific place. The communication unit can also propose the optimal connection method based on the user's geographic location information. The communication unit can also provide the optimal connection method by taking into account the user's geographic location information. Thus, the communication unit can provide the optimal connection method based on geographic location information.

The display unit can refer to the user's past display history at the time of display to select the optimal display method. The display unit, for example, refers to the user's past display history at the time of display to select the optimal display method. For example, the display unit preferentially uses display methods previously used by the user. The display unit can also select the most effective display method from the user's past display history. The display unit can also analyze the user's past display history to propose the optimal display method. Thus, the display unit can provide the optimal display method based on past display history.

The display unit can select the optimal display method by taking into account the user's geographic location information at the time of display. The display unit, for example, selects the optimal display method by taking into account the user's geographic location information at the time of display. For example, the display unit selects the optimal display method according to the location when the user is in a specific place. The display unit can also propose the optimal display method based on the user's geographic location information. The display unit can also provide the optimal display method by taking into account the user's geographic location information. Thus, the display unit can provide the optimal display method based on geographic location information.

The system according to the embodiment is not limited to the above examples, and various modifications are possible, for example, as described below.

The authentication unit can additionally acquire the user's biometric information to enhance the reliability of authentication. For example, the authentication unit measures the user's heart rate or body temperature and checks whether it is within the normal range. The authentication unit can also comprehensively analyze the user's biometric information to enhance the reliability of authentication. Thus, the authentication unit can improve the reliability of authentication based on biometric information.

The monitoring unit can learn the user's behavior patterns and detect abnormal behavior. For example, if the monitoring unit detects behavior that the user does not normally perform, it issues an alert. The monitoring unit can also analyze the user's behavior patterns and propose efficient learning methods. Thus, the monitoring unit can improve learning efficiency based on the user's behavior patterns.

The assist unit can customize the way hints are provided according to the user's learning style. For example, the assist unit provides hints via visual presentation for users who prefer visual learning. For users who prefer auditory learning, the assist unit can provide hints via voice messages. Thus, the assist unit can provide optimal hints according to the user's learning style.

The selection unit can select questions based on the user's learning goals. For example, if the user's goal is to pass a specific exam, the selection unit prioritizes questions related to that exam. The selection unit can also propose a long-term learning plan according to the user's learning goals. Thus, the selection unit can provide optimal questions according to the user's learning goals.

The temperature control unit can adjust the temperature based on the user's activity level. For example, if the user is actively moving, the temperature control unit lowers the room temperature to provide a comfortable environment. If the user is sitting quietly, the temperature control unit raises the room temperature to provide a comfortable environment. Thus, the temperature control unit can provide the optimal temperature according to the user's activity level.

The following is a brief description of the processing flow of Example 1 of the Embodiment.
Step 1: The authentication unit recognizes the user. For example, the user can be recognized by methods such as facial recognition, fingerprint recognition, or voice recognition.
Step 2: The retrieval unit retrieves the learning data of the user recognized by the authentication unit. For example, it can retrieve learning data such as text data, image data, or audio data.
Step 3: The monitoring unit monitors the user's movements. For example, the user's movements can be monitored by methods such as motion detection using a camera or motion detection using sensors.
Step 4: The assist unit provides hints when the movement monitored by the monitoring unit stops. For example, hints can be provided by methods such as text messages, voice messages, or visual presentation.
Step 5: The selection unit selects questions previously answered incorrectly and presents them again. For example, questions previously answered incorrectly can be selected based on criteria such as the number of mistakes or the content of the mistakes.
Step 6: The temperature control unit performs automatic temperature adjustment by AI. For example, automatic temperature adjustment can be performed by methods such as using temperature sensors or types of learning algorithms.
Step 7: The blocking unit blocks external radio waves. For example, external radio waves can be blocked by methods such as using radio wave blocking materials or shielding technology.
Step 8: The communication unit provides Wi-Fi. For example, Wi-Fi can be provided by methods such as types of routers or communication protocols.
Step 9: The display unit displays information on a monitor. For example, information can be displayed by methods such as types of displays or display formats.

### Example 2 of the Embodiment

The learning support system according to the embodiment of the present invention is a system that provides an environment in which a user can concentrate and learn intensively in a short period of time. This learning support system is equipped with facial recognition, AI camera, AI-based automatic temperature control, radio wave blocking box, Wi-Fi, and monitor in a phone booth-sized box, similar to a phone booth, to create an environment where users can concentrate and learn intensively in a short time. First, when the user enters the phone booth, the facial recognition system recognizes the user and retrieves individual learning data. Next, the AI camera monitors the user's movements and tracks the learning progress in real time. For example, if the user's movement stops in response to a question, the generative AI provides a hint after a few seconds. It also has a function to select questions previously answered incorrectly and present them again. Furthermore, it is equipped with an AI-based automatic temperature control function to maintain a comfortable learning environment for the user. The radio wave blocking box prevents external interference and enhances concentration. With Wi-Fi and a monitor, it is also compatible with online learning and remote meetings. With this system, users can efficiently proceed with learning in a short period of time and maintain high productivity even in today's society where deadlines are pressing. For example, when the user enters the phone booth, the facial recognition system recognizes the user and retrieves individual learning data. Next, the AI camera monitors the user's movements and tracks the learning progress in real time. For example, if the user's movement stops in response to a question, the generative AI provides a hint after a few seconds. It also has a function to select questions previously answered incorrectly and present them again. Furthermore, it is equipped with an AI-based automatic temperature control function to maintain a comfortable learning environment for the user. The radio wave blocking box prevents external interference and enhances concentration. With Wi-Fi and a monitor, it is also compatible with online learning and remote meetings. With this system, users can efficiently proceed with learning in a short period of time and maintain high productivity even in today's society where deadlines are pressing. Thus, the learning support system can optimize the user's learning environment and support efficient learning.

The learning support system according to the embodiment comprises an authentication unit, a retrieval unit, a monitoring unit, an assist unit, a selection unit, a temperature control unit, a blocking unit, a communication unit, and a display unit. The authentication unit recognizes the user. For example, the user can be recognized by methods such as facial recognition, fingerprint recognition, or voice recognition. The retrieval unit retrieves the learning data of the user recognized by the authentication unit. For example, it can retrieve learning data such as text data, image data, or audio data. The monitoring unit monitors the user's movements. For example, the user's movements can be monitored by methods such as motion detection using a camera or motion detection using sensors. The assist unit provides hints when the movement monitored by the monitoring unit stops. For example, hints can be provided by methods such as text messages, voice messages, or visual presentation. The selection unit selects questions previously answered incorrectly and presents them again. For example, questions previously answered incorrectly can be selected based on criteria such as the number of mistakes or the content of the mistakes. The temperature control unit performs automatic temperature adjustment by AI. For example, automatic temperature adjustment can be performed by methods such as using temperature sensors or types of learning algorithms. The blocking unit blocks external radio waves. For example, external radio waves can be blocked by methods such as using radio wave blocking materials or shielding technology. The communication unit provides Wi-Fi. For example, Wi-Fi can be provided by methods such as types of routers or communication protocols. The display unit displays information on a monitor. For example, information can be displayed by methods such as types of displays or display formats. Thus, the learning support system according to the embodiment can optimize the user's learning environment and support efficient learning.

The monitoring unit can monitor the user's movements in real time. The monitoring unit, for example, monitors the user's movements in real time using a camera. For example, the monitoring unit captures the user's movements with a high-resolution camera and analyzes the movements in real time. The monitoring unit can also monitor the user's movements in real time using sensors. For example, the monitoring unit detects the user's movements with a motion sensor and analyzes the movements in real time. The monitoring unit can also monitor the user's movements in real time using AI. For example, the monitoring unit analyzes the user's movements using an AI camera and monitors the movements in real time. Thus, by monitoring the user's movements in real time, the monitoring unit can accurately grasp the progress of learning.

The assist unit can provide a hint after a certain period of time when the user's movement stops. The assist unit, for example, provides a hint a few seconds after the user's movement stops. For example, the assist unit provides a hint via a text message a few seconds after the user's movement stops in response to a question. The assist unit can also provide a hint via a voice message when the user's movement stops. For example, the assist unit provides a hint via a voice message a few seconds after the user's movement stops in response to a question. The assist unit can also provide a hint via visual presentation when the user's movement stops. For example, the assist unit provides a hint via visual presentation a few seconds after the user's movement stops in response to a question. Thus, the assist unit can provide appropriate hints at the right timing when the user is stuck on a question.

The selection unit can select questions previously answered incorrectly and present them again. The selection unit, for example, selects questions previously answered incorrectly and presents them again. For example, the selection unit extracts questions previously answered incorrectly by the user from a database and presents them again. The selection unit can also select questions based on the number of times they were answered incorrectly. For example, the selection unit selects questions to be presented again based on the number of times the user answered them incorrectly in the past. The selection unit can also select questions based on the content of the mistakes. For example, the selection unit selects questions to be presented again based on the content of the user's past mistakes. Thus, the selection unit can provide effective review based on the user's past learning history.

The temperature control unit can perform automatic temperature adjustment by AI. The temperature control unit, for example, performs automatic temperature adjustment using AI. For example, the temperature control unit measures the room temperature using a temperature sensor, and the AI calculates the optimal temperature and automatically adjusts it. The temperature control unit can also measure the user's body temperature and the AI calculates the optimal room temperature and automatically adjusts it. For example, the temperature control unit measures the user's body temperature with a sensor, and the AI calculates the optimal room temperature and automatically adjusts it. The temperature control unit can also monitor the user's movements and the AI calculates the optimal temperature and automatically adjusts it. For example, the temperature control unit monitors the user's movements with a camera, and the AI calculates the optimal temperature and automatically adjusts it. Thus, the temperature control unit can maintain a comfortable learning environment for the user.

The blocking unit can block external radio waves. The blocking unit, for example, blocks external radio waves using radio wave blocking materials. For example, the blocking unit blocks external radio waves using radio wave blocking materials. The blocking unit can also block external radio waves using shielding technology. For example, the blocking unit blocks external radio waves using shielding technology. The blocking unit can also block external radio waves using radio wave blocking films. For example, the blocking unit blocks external radio waves using radio wave blocking films. Thus, the blocking unit can prevent external interference and enhance concentration.

The communication unit can provide Wi-Fi. The communication unit, for example, provides Wi-Fi using a router. For example, the communication unit provides Wi-Fi using a router. The communication unit can also provide Wi-Fi using communication protocols. For example, the communication unit provides Wi-Fi using communication protocols. The communication unit can also provide Wi-Fi using Wi-Fi access points. For example, the communication unit provides Wi-Fi using Wi-Fi access points. Thus, the communication unit enables online learning and remote meetings.

The display unit can display information on a monitor. The display unit, for example, displays information using a display. For example, the display unit displays information using a display. The display unit can also display information using display formats. For example, the display unit displays information using display formats. The display unit can also display information using a projector. For example, the display unit displays information using a projector. Thus, the display unit allows users to visually check learning content and meeting materials.

The authentication unit can estimate the user's emotion and adjust the speed of the authentication process based on the estimated emotion. For example, the authentication unit estimates the user's emotion and adjusts the speed of the authentication process based on the estimated emotion. For example, if the user is feeling stressed, the authentication process is performed quickly to reduce the user's burden. If the user is relaxed, the authentication process is performed at a normal speed, allowing for detailed verification. If the user is in a hurry, the authentication process is accelerated to quickly retrieve learning data. Thus, the authentication unit can provide an authentication process according to the user's emotion and reduce the user's burden.

The authentication unit can refer to the user's past authentication history at the time of authentication to improve authentication accuracy. The authentication unit, for example, refers to the user's past authentication history at the time of authentication to improve authentication accuracy. For example, the authentication unit preferentially uses authentication methods (such as facial recognition or fingerprint recognition) that the user has used in the past. The authentication unit can also predict the time required for authentication from the user's past authentication history and propose the optimal authentication method. The authentication unit can also analyze the user's past authentication history to find patterns for improving authentication accuracy. Thus, the authentication unit can improve authentication accuracy based on past authentication history.

The authentication unit can additionally acquire the user's biometric information at the time of authentication to enhance the reliability of authentication. The authentication unit, for example, additionally acquires the user's biometric information (such as heart rate or body temperature) at the time of authentication to enhance the reliability of authentication. For example, the authentication unit measures the user's heart rate and checks whether it is within the normal range. The authentication unit can also measure the user's body temperature and check for abnormalities. The authentication unit can also comprehensively analyze the user's biometric information to enhance the reliability of authentication. Thus, the authentication unit can improve the reliability of authentication based on biometric information.

The authentication unit can estimate the user's emotion and select an authentication method based on the estimated emotion. For example, the authentication unit estimates the user's emotion and selects an authentication method based on the estimated emotion. For example, if the user is nervous, facial recognition is prioritized for quick authentication. If the user is relaxed, fingerprint authentication is used for detailed verification. If the user is in a hurry, voice authentication is used for quick authentication. Thus, the authentication unit can provide the optimal authentication method according to the user's emotion.

The authentication unit can customize the authentication process by taking into account the user's geographic location information at the time of authentication. The authentication unit, for example, customizes the authentication process by taking into account the user's geographic location information at the time of authentication. For example, the authentication unit provides a simplified authentication process when the user is at home. The authentication unit can also provide a detailed authentication process when the user is in a public place. The authentication unit can also provide an authentication method appropriate for the location when the user is in a specific place. Thus, the authentication unit can optimize the authentication process based on geographic location information.

The authentication unit can analyze the user's social media activity at the time of authentication to improve the reliability of authentication. The authentication unit, for example, analyzes the user's social media activity at the time of authentication to improve the reliability of authentication. For example, the authentication unit grasps the user's current situation from social media activity and adjusts the authentication process. The authentication unit can also analyze the user's social media activity to find patterns for improving the reliability of authentication. The authentication unit can also select an authentication method based on the user's social media activity. Thus, the authentication unit can improve the reliability of authentication based on social media activity.

The retrieval unit can estimate the user's emotion and adjust the order of retrieving learning data based on the estimated emotion. For example, the retrieval unit estimates the user's emotion and adjusts the order of retrieving learning data based on the estimated emotion. For example, if the user is feeling stressed, the retrieval starts with easy questions. If the user is relaxed, the retrieval starts with more difficult questions. If the user is in a hurry, the retrieval starts with important questions. Thus, the retrieval unit can provide the optimal order of retrieving learning data according to the user's emotion.

The retrieval unit can refer to the user's past learning history at the time of retrieval to select optimal learning data. The retrieval unit, for example, refers to the user's past learning history at the time of retrieval to select optimal learning data. For example, the retrieval unit preferentially retrieves questions previously answered incorrectly by the user. The retrieval unit can also select the most effective learning data from the user's past learning history. The retrieval unit can also analyze the user's past learning history to propose optimal learning data. Thus, the retrieval unit can provide optimal learning data based on past learning history.

The retrieval unit can customize data based on the user's current learning progress at the time of retrieval. The retrieval unit, for example, customizes data based on the user's current learning progress at the time of retrieval. For example, the retrieval unit proposes the next learning data to be studied according to the user's current learning progress. The retrieval unit can also grasp the user's learning progress in real time and provide optimal learning data. The retrieval unit can also analyze the user's learning progress to select effective learning data. Thus, the retrieval unit can provide optimal learning data based on the current learning progress.

The retrieval unit can estimate the user's emotion and adjust the display method of learning data based on the estimated emotion. For example, the retrieval unit estimates the user's emotion and adjusts the display method of learning data based on the estimated emotion. For example, if the user is nervous, a simple and highly visible display method is provided. If the user is relaxed, a display method including detailed information can be provided. If the user is in a hurry, a display method focusing on key points can be provided. Thus, the retrieval unit can provide the optimal display method according to the user's emotion.

The retrieval unit can prioritize the retrieval of highly relevant learning data by taking into account the user's geographic location information at the time of retrieval. The retrieval unit, for example, prioritizes the retrieval of highly relevant learning data by taking into account the user's geographic location information at the time of retrieval. For example, the retrieval unit prioritizes the retrieval of learning data related to the location when the user is in a specific place. The retrieval unit can also propose optimal learning data based on the user's geographic location information. The retrieval unit can also provide highly relevant learning data by taking into account the user's geographic location information. Thus, the retrieval unit can provide highly relevant learning data based on geographic location information.

The retrieval unit can analyze the user's social media activity at the time of retrieval to retrieve relevant learning data. The retrieval unit, for example, analyzes the user's social media activity at the time of retrieval to retrieve relevant learning data. For example, the retrieval unit grasps the user's current interests from social media activity and provides relevant learning data. The retrieval unit can also analyze the user's social media activity to propose optimal learning data. The retrieval unit can also retrieve highly relevant learning data based on the user's social media activity. Thus, the retrieval unit can provide highly relevant learning data based on social media activity.

The monitoring unit can estimate the user's emotion and adjust the monitoring frequency based on the estimated emotion. For example, the monitoring unit estimates the user's emotion and adjusts the monitoring frequency based on the estimated emotion. For example, if the user is feeling stressed, the monitoring frequency is lowered to reduce the user's burden. If the user is relaxed, monitoring can be performed at a normal frequency. If the user is in a hurry, the monitoring frequency is increased for quick response. Thus, the monitoring unit can provide the optimal monitoring frequency according to the user's emotion.

The monitoring unit can refer to the user's past behavior patterns at the time of monitoring to improve monitoring accuracy. The monitoring unit, for example, refers to the user's past behavior patterns at the time of monitoring to improve monitoring accuracy. For example, the monitoring unit proposes optimal monitoring methods based on the user's past behavior patterns. The monitoring unit can also analyze the user's past behavior patterns to find patterns for improving monitoring accuracy. The monitoring unit can also adjust the timing of monitoring by referring to the user's past behavior patterns. Thus, the monitoring unit can improve monitoring accuracy based on past behavior patterns.

The monitoring unit can additionally acquire the user's biometric information at the time of monitoring to enhance the reliability of monitoring. The monitoring unit, for example, additionally acquires the user's biometric information (such as heart rate or body temperature) at the time of monitoring to enhance the reliability of monitoring. For example, the monitoring unit measures the user's heart rate and checks whether it is within the normal range. The monitoring unit can also measure the user's body temperature and check for abnormalities. The monitoring unit can also comprehensively analyze the user's biometric information to enhance the reliability of monitoring. Thus, the monitoring unit can improve the reliability of monitoring based on biometric information.

The monitoring unit can estimate the user's emotion and adjust the display method of monitoring results based on the estimated emotion. For example, the monitoring unit estimates the user's emotion and adjusts the display method of the monitoring results according to the estimated emotion. For example, when the user is feeling nervous, the monitoring unit provides a simple and highly visible display method. Furthermore, when the user is relaxed, the monitoring unit can provide a display method that includes detailed information. Additionally, when the user is in a hurry, the monitoring unit can provide a display method that emphasizes key points. In this way, the monitoring unit can provide the optimal display method according to the user's emotion.

The monitoring unit can customize the monitoring range by taking into account the user's geographic location information at the time of monitoring. The monitoring unit, for example, customizes the monitoring range by taking into account the user's geographic location information at the time of monitoring. For example, the monitoring unit sets the monitoring range according to the location when the user is in a specific place. The monitoring unit can also propose the optimal monitoring range based on the user's geographic location information. The monitoring unit can also adjust the monitoring range by taking into account the user's geographic location information. Thus, the monitoring unit can provide the optimal monitoring range based on geographic location information.

The monitoring unit can analyze the user's social media activity at the time of monitoring to improve monitoring accuracy. The monitoring unit, for example, analyzes the user's social media activity at the time of monitoring to improve monitoring accuracy. For example, the monitoring unit grasps the user's current situation from social media activity and improves monitoring accuracy. The monitoring unit can also analyze the user's social media activity to propose optimal monitoring methods. The monitoring unit can also adjust the monitoring range based on the user's social media activity. Thus, the monitoring unit can improve monitoring accuracy based on social media activity.

The assist unit can estimate the user's emotion and adjust the way hints are provided based on the estimated emotion. For example, the assist unit estimates the user's emotion and adjusts the way hints are provided based on the estimated emotion. For example, if the user is feeling stressed, simple hints are provided to reduce the user's burden. If the user is relaxed, detailed hints are provided to support learning. If the user is in a hurry, hints are provided quickly to improve learning efficiency. Thus, the assist unit can provide optimal hints according to the user's emotion.

The assist unit can refer to the user's past learning history at the time of assistance to provide optimal hints. The assist unit, for example, refers to the user's past learning history at the time of assistance to provide optimal hints. For example, the assist unit provides relevant hints for questions previously answered incorrectly by the user. The assist unit can also select the most effective hints from the user's past learning history. The assist unit can also analyze the user's past learning history to propose optimal hints. Thus, the assist unit can provide optimal hints based on past learning history.

The assist unit can customize hints based on the user's current learning progress at the time of assistance. The assist unit, for example, customizes hints based on the user's current learning progress at the time of assistance. For example, the assist unit provides hints related to the next content to be learned according to the user's current learning progress. The assist unit can also grasp the user's learning progress in real time and provide optimal hints. The assist unit can also analyze the user's learning progress to select effective hints. Thus, the assist unit can provide optimal hints based on the current learning progress.

The assist unit can estimate the user's emotion and adjust the display method of hints based on the estimated emotion. For example, the assist unit estimates the user's emotion and adjusts the display method of hints based on the estimated emotion. For example, if the user is nervous, a simple and highly visible display method is provided. If the user is relaxed, a display method including detailed information can be provided. If the user is in a hurry, a display method focusing on key points can be provided. Thus, the assist unit can provide the optimal display method according to the user's emotion.

The assist unit can prioritize the provision of highly relevant hints by taking into account the user's geographic location information at the time of assistance. The assist unit, for example, prioritizes the provision of highly relevant hints by taking into account the user's geographic location information at the time of assistance. For example, the assist unit prioritizes the provision of hints related to the location when the user is in a specific place. The assist unit can also propose optimal hints based on the user's geographic location information. The assist unit can also provide highly relevant hints by taking into account the user's geographic location information. Thus, the assist unit can provide highly relevant hints based on geographic location information.

The assist unit can analyze the user's social media activity at the time of assistance to provide relevant hints. The assist unit, for example, analyzes the user's social media activity at the time of assistance to provide relevant hints. For example, the assist unit grasps the user's current interests from social media activity and provides relevant hints. The assist unit can also analyze the user's social media activity to propose optimal hints. The assist unit can also provide highly relevant hints based on the user's social media activity. Thus, the assist unit can provide highly relevant hints based on social media activity.

The selection unit can estimate the user's emotion and adjust the timing of re-presentation based on the estimated emotion. For example, the selection unit estimates the user's emotion and adjusts the timing of re-presentation based on the estimated emotion. For example, if the user is feeling stressed, the timing of re-presentation is delayed. If the user is relaxed, re-presentation is performed at the normal timing. If the user is in a hurry, the timing of re-presentation is advanced. Thus, the selection unit can provide the optimal timing of re-presentation according to the user's emotion.

The selection unit can refer to the user's past learning history at the time of selection to select optimal questions. The selection unit, for example, refers to the user's past learning history at the time of selection to select optimal questions. For example, the selection unit preferentially selects questions previously answered incorrectly by the user. The selection unit can also select the most effective questions from the user's past learning history. The selection unit can also analyze the user's past learning history to propose optimal questions. Thus, the selection unit can provide optimal questions based on past learning history.

The selection unit can customize questions based on the user's current learning progress at the time of selection. The selection unit, for example, customizes questions based on the user's current learning progress at the time of selection. For example, the selection unit selects the next questions to be learned according to the user's current learning progress. The selection unit can also grasp the user's learning progress in real time and provide optimal questions. The selection unit can also analyze the user's learning progress to select effective questions. Thus, the selection unit can provide optimal questions based on the current learning progress.

The selection unit can estimate the user's emotion and adjust the display method of re-presentation based on the estimated emotion. For example, the selection unit estimates the user's emotion and adjusts the display method of re-presentation based on the estimated emotion. For example, if the user is nervous, a simple and highly visible display method is provided. If the user is relaxed, a display method including detailed information can be provided. If the user is in a hurry, a display method focusing on key points can be provided. Thus, the selection unit can provide the optimal display method according to the user's emotion.

The selection unit can prioritize the selection of highly relevant questions by taking into account the user's geographic location information at the time of selection. The selection unit, for example, prioritizes the selection of highly relevant questions by taking into account the user's geographic location information at the time of selection. For example, the selection unit prioritizes the selection of questions related to the location when the user is in a specific place. The selection unit can also propose optimal questions based on the user's geographic location information. The selection unit can also provide highly relevant questions by taking into account the user's geographic location information. Thus, the selection unit can provide highly relevant questions based on geographic location information.

The selection unit can analyze the user's social media activity at the time of selection to select relevant questions. The selection unit, for example, analyzes the user's social media activity at the time of selection to select relevant questions. For example, the selection unit grasps the user's current interests from social media activity and provides relevant questions. The selection unit can also analyze the user's social media activity to propose optimal questions. The selection unit can also select highly relevant questions based on the user's social media activity. Thus, the selection unit can provide highly relevant questions based on social media activity.

The temperature control unit can estimate the user's emotion and adjust the frequency of temperature adjustment based on the estimated emotion. For example, the temperature control unit estimates the user's emotion and adjusts the frequency of temperature adjustment based on the estimated emotion. For example, if the user is feeling stressed, the frequency of temperature adjustment is increased to maintain a comfortable environment. If the user is relaxed, temperature adjustment can be performed at a normal frequency. If the user is in a hurry, the frequency of temperature adjustment is decreased to maintain concentration. Thus, the temperature control unit can provide the optimal frequency of temperature adjustment according to the user's emotion.

The temperature control unit can refer to the user's past temperature setting history at the time of temperature adjustment to set the optimal temperature. The temperature control unit, for example, refers to the user's past temperature setting history at the time of temperature adjustment to set the optimal temperature. For example, the temperature control unit proposes the optimal temperature based on the temperatures previously set by the user. The temperature control unit can also select the most comfortable temperature from the user's past temperature setting history. The temperature control unit can also analyze the user's past temperature setting history to set the optimal temperature. Thus, the temperature control unit can provide the optimal temperature based on past temperature setting history.

The temperature control unit can additionally acquire the user's biometric information at the time of temperature adjustment to enhance the reliability of temperature control. The temperature control unit, for example, additionally acquires the user's biometric information (such as heart rate or body temperature) at the time of temperature adjustment to enhance the reliability of temperature control. For example, the temperature control unit measures the user's heart rate and checks whether it is within the normal range. The temperature control unit can also measure the user's body temperature and check for abnormalities. The temperature control unit can also comprehensively analyze the user's biometric information to set the optimal temperature. Thus, the temperature control unit can provide the optimal temperature based on biometric information.

The temperature control unit can estimate the user's emotion and select a temperature adjustment method based on the estimated emotion. For example, the temperature control unit estimates the user's emotion and selects a temperature adjustment method based on the estimated emotion. For example, if the user is nervous, cooling is prioritized to provide a comfortable environment. If the user is relaxed, normal temperature adjustment can be performed. If the user is in a hurry, temperature adjustment is performed quickly to maintain concentration. Thus, the temperature control unit can provide the optimal temperature adjustment method according to the user's emotion.

The temperature control unit can set the optimal temperature by taking into account the user's geographic location information at the time of temperature adjustment. The temperature control unit, for example, sets the optimal temperature by taking into account the user's geographic location information at the time of temperature adjustment. For example, the temperature control unit sets the optimal temperature according to the location when the user is in a specific place. The temperature control unit can also propose the optimal temperature based on the user's geographic location information. The temperature control unit can also set the optimal temperature by taking into account the user's geographic location information. Thus, the temperature control unit can provide the optimal temperature based on geographic location information.

The temperature control unit can analyze the user's social media activity at the time of temperature adjustment to provide relevant temperature settings. The temperature control unit, for example, analyzes the user's social media activity at the time of temperature adjustment to provide relevant temperature settings. For example, the temperature control unit grasps the user's current situation from social media activity and sets the optimal temperature. The temperature control unit can also analyze the user's social media activity to propose the optimal temperature. The temperature control unit can also provide highly relevant temperature settings based on the user's social media activity. Thus, the temperature control unit can provide the optimal temperature based on social media activity.

The blocking unit can estimate the user's emotion and adjust the timing of radio wave blocking based on the estimated emotion. For example, the blocking unit estimates the user's emotion and adjusts the timing of radio wave blocking based on the estimated emotion. For example, if the user is feeling stressed, the timing of radio wave blocking is advanced. If the user is relaxed, radio wave blocking can be performed at the normal timing. If the user is in a hurry, the timing of radio wave blocking is delayed. Thus, the blocking unit can provide the optimal timing of radio wave blocking according to the user's emotion.

The blocking unit can refer to the user's past blocking history at the time of blocking to select the optimal blocking method. The blocking unit, for example, refers to the user's past blocking history at the time of blocking to select the optimal blocking method. For example, the blocking unit preferentially uses blocking methods previously used by the user. The blocking unit can also select the most effective blocking method from the user's past blocking history. The blocking unit can also analyze the user's past blocking history to propose the optimal blocking method. Thus, the blocking unit can provide the optimal blocking method based on past blocking history.

The blocking unit can estimate the user's emotion and select a blocking method based on the estimated emotion. For example, the blocking unit estimates the user's emotion and selects a blocking method based on the estimated emotion. For example, if the user is nervous, complete radio wave blocking is performed to enhance concentration. If the user is relaxed, partial radio wave blocking can be performed. If the user is in a hurry, radio wave blocking is not performed and work proceeds quickly. Thus, the blocking unit can provide the optimal blocking method according to the user's emotion.

The blocking unit can select the optimal blocking method by taking into account the user's geographic location information at the time of blocking. The blocking unit, for example, selects the optimal blocking method by taking into account the user's geographic location information at the time of blocking. For example, the blocking unit selects the optimal blocking method according to the location when the user is in a specific place. The blocking unit can also propose the optimal blocking method based on the user's geographic location information. The blocking unit can also provide the optimal blocking method by taking into account the user's geographic location information. Thus, the blocking unit can provide the optimal blocking method based on geographic location information.

The communication unit can estimate the user's emotion and adjust the Wi-Fi connection speed based on the estimated emotion. For example, the communication unit estimates the user's emotion and adjusts the Wi-Fi connection speed based on the estimated emotion. For example, if the user is feeling stressed, the Wi-Fi connection speed is increased to provide a comfortable communication environment. If the user is relaxed, communication can be performed at the normal connection speed. If the user is in a hurry, the Wi-Fi connection speed is maximized for quick communication. Thus, the communication unit can provide the optimal Wi-Fi connection speed according to the user's emotion.

The communication unit can refer to the user's past communication history at the time of communication to select the optimal connection method. The communication unit, for example, refers to the user's past communication history at the time of communication to select the optimal connection method. For example, the communication unit preferentially uses connection methods previously used by the user. The communication unit can also select the most effective connection method from the user's past communication history. The communication unit can also analyze the user's past communication history to propose the optimal connection method. Thus, the communication unit can provide the optimal connection method based on past communication history.

The communication unit can estimate the user's emotion and select a Wi-Fi connection method based on the estimated emotion. For example, the communication unit estimates the user's emotion and selects a Wi-Fi connection method based on the estimated emotion. For example, if the user is nervous, a stable connection method is prioritized. If the user is relaxed, a normal connection method can be used. If the user is in a hurry, the fastest connection method is selected. Thus, the communication unit can provide the optimal Wi-Fi connection method according to the user's emotion.

The communication unit can select the optimal connection method by taking into account the user's geographic location information at the time of communication. The communication unit, for example, selects the optimal connection method by taking into account the user's geographic location information at the time of communication. For example, the communication unit selects the optimal connection method according to the location when the user is in a specific place. The communication unit can also propose the optimal connection method based on the user's geographic location information. The communication unit can also provide the optimal connection method by taking into account the user's geographic location information. Thus, the communication unit can provide the optimal connection method based on geographic location information.

The display unit can estimate the user's emotion and adjust the display content based on the estimated emotion. For example, the display unit estimates the user's emotion and adjusts the display content based on the estimated emotion. For example, if the user is feeling stressed, simple and highly visible display content is provided. If the user is relaxed, display content including detailed information can be provided. If the user is in a hurry, display content focusing on key points can be provided. Thus, the display unit can provide the optimal display content according to the user's emotion.

The display unit can refer to the user's past display history at the time of display to select the optimal display method. The display unit, for example, refers to the user's past display history at the time of display to select the optimal display method. For example, the display unit preferentially uses display methods previously used by the user. The display unit can also select the most effective display method from the user's past display history. The display unit can also analyze the user's past display history to propose the optimal display method. Thus, the display unit can provide the optimal display method based on past display history.

The display unit can estimate the user's emotion and select a display method based on the estimated emotion. For example, the display unit estimates the user's emotion and selects a display method based on the estimated emotion. For example, if the user is nervous, a simple and highly visible display method is provided. If the user is relaxed, a display method including detailed information can be provided. If the user is in a hurry, a display method focusing on key points can be provided. Thus, the display unit can provide the optimal display method according to the user's emotion.

The display unit can select the optimal display method by taking into account the user's geographic location information at the time of display. The display unit, for example, selects the optimal display method by taking into account the user's geographic location information at the time of display. For example, the display unit selects the optimal display method according to the location when the user is in a specific place. The display unit can also propose the optimal display method based on the user's geographic location information. The display unit can also provide the optimal display method by taking into account the user's geographic location information. Thus, the display unit can provide the optimal display method based on geographic location information.

The system according to the embodiment is not limited to the above examples, and various modifications are possible, for example, as described below.

The authentication unit can additionally acquire the user's biometric information to enhance the reliability of authentication. For example, the authentication unit measures the user's heart rate or body temperature and checks whether it is within the normal range. The authentication unit can also comprehensively analyze the user's biometric information to enhance the reliability of authentication. Thus, the authentication unit can improve the reliability of authentication based on biometric information.

The monitoring unit can learn the user's behavior patterns and detect abnormal behavior. For example, if the monitoring unit detects behavior that the user does not normally perform, it issues an alert. The monitoring unit can also analyze the user's behavior patterns and propose efficient learning methods. Thus, the monitoring unit can improve learning efficiency based on the user's behavior patterns.

The assist unit can customize the way hints are provided according to the user's learning style. For example, the assist unit provides hints via visual presentation for users who prefer visual learning. For users who prefer auditory learning, the assist unit can provide hints via voice messages. Thus, the assist unit can provide optimal hints according to the user's learning style.

The selection unit can select questions based on the user's learning goals. For example, if the user's goal is to pass a specific exam, the selection unit prioritizes questions related to that exam. The selection unit can also propose a long-term learning plan according to the user's learning goals. Thus, the selection unit can provide optimal questions according to the user's learning goals.

The temperature control unit can adjust the temperature based on the user's activity level. For example, if the user is actively moving, the temperature control unit lowers the room temperature to provide a comfortable environment. If the user is sitting quietly, the temperature control unit raises the room temperature to provide a comfortable environment. Thus, the temperature control unit can provide the optimal temperature according to the user's activity level.

The authentication unit can estimate the user's emotion and adjust the speed of the authentication process based on the estimated emotion. For example, if the user is feeling stressed, the authentication process is performed quickly to reduce the user's burden. If the user is relaxed, the authentication process is performed at a normal speed, allowing for detailed verification. Thus, the authentication unit can provide an authentication process according to the user's emotion and reduce the user's burden.

The retrieval unit can estimate the user's emotion and adjust the order of retrieving learning data based on the estimated emotion. For example, if the user is feeling stressed, the retrieval starts with easy questions. If the user is relaxed, the retrieval starts with more difficult questions. Thus, the retrieval unit can provide the optimal order of retrieving learning data according to the user's emotion.

The monitoring unit can estimate the user's emotion and adjust the monitoring frequency based on the estimated emotion. For example, if the user is feeling stressed, the monitoring frequency is lowered to reduce the user's burden. If the user is relaxed, monitoring can be performed at a normal frequency. Thus, the monitoring unit can provide the optimal monitoring frequency according to the user's emotion.

The assist unit can estimate the user's emotion and adjust the way hints are provided based on the estimated emotion. For example, if the user is feeling stressed, simple hints are provided to reduce the user's burden. If the user is relaxed, detailed hints are provided to support learning. Thus, the assist unit can provide optimal hints according to the user's emotion.

The selection unit can estimate the user's emotion and adjust the timing of re-presentation based on the estimated emotion. For example, if the user is feeling stressed, the timing of re-presentation is delayed. If the user is relaxed, re-presentation is performed at the normal timing. Thus, the selection unit can provide the optimal timing of re-presentation according to the user's emotion.

The following is a brief description of the processing flow of Example 2 of the Embodiment.
Step 1: The authentication unit recognizes the user. For example, the user can be recognized by methods such as facial recognition, fingerprint recognition, or voice recognition.
Step 2: The retrieval unit retrieves the learning data of the user recognized by the authentication unit. For example, it can retrieve learning data such as text data, image data, or audio data.
Step 3: The monitoring unit monitors the user's movements. For example, the user's movements can be monitored by methods such as motion detection using a camera or motion detection using sensors.
Step 4: The assist unit provides hints when the movement monitored by the monitoring unit stops. For example, hints can be provided by methods such as text messages, voice messages, or visual presentation.
Step 5: The selection unit selects questions previously answered incorrectly and presents them again. For example, questions previously answered incorrectly can be selected based on criteria such as the number of mistakes or the content of the mistakes.
Step 6: The temperature control unit performs automatic temperature adjustment by AI. For example, automatic temperature adjustment can be performed by methods such as using temperature sensors or types of learning algorithms.
Step 7: The blocking unit blocks external radio waves. For example, external radio waves can be blocked by methods such as using radio wave blocking materials or shielding technology.
Step 8: The communication unit provides Wi-Fi. For example, Wi-Fi can be provided by methods such as types of routers or communication protocols.
Step 9: The display unit displays information on a monitor. For example, information can be displayed by methods such as types of displays or display formats.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the authentication unit, retrieval unit, monitoring unit, assist unit, selection unit, temperature control unit, blocking unit, communication unit, and display unit, is implemented, for example, in at least one of the smart device 14 and the data processing apparatus 12. For example, the authentication unit recognizes the user using the camera 42 or microphone 38B of the smart device 14 and executes the authentication process by the control unit 46A. The retrieval unit retrieves the user's learning data by the specific processing unit 290 of the data processing apparatus 12. The monitoring unit monitors the user's movements using the camera 42 of the smart device 14 and processes the monitoring data by the control unit 46A. The assist unit generates hints by the specific processing unit 290 of the data processing apparatus 12 and presents them through the output device 40 of the smart device 14. The selection unit selects questions previously answered incorrectly and presents them again by the specific processing unit 290 of the data processing apparatus 12. The temperature control unit performs automatic temperature adjustment by the control unit 46A of the smart device 14. The blocking unit blocks external radio waves using the shielding technology of the smart device 14. The communication unit provides Wi-Fi using the communication I/F 44 of the smart device 14. The display unit displays information using the display 40A of the smart device 14. The correspondence between each unit and the device or control unit is not limited to the above examples and various modifications are possible.

### Second Embodiment

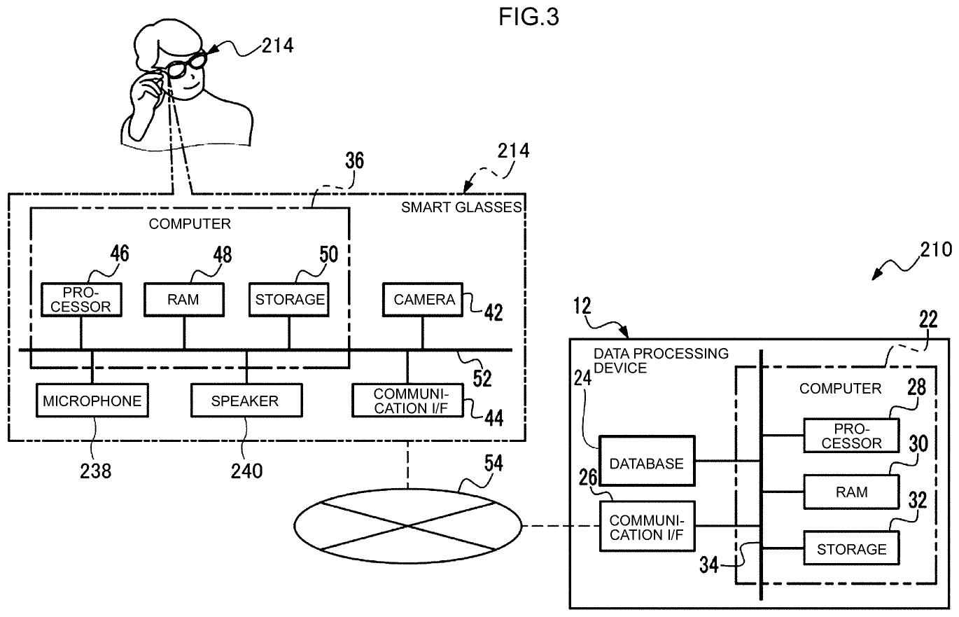

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

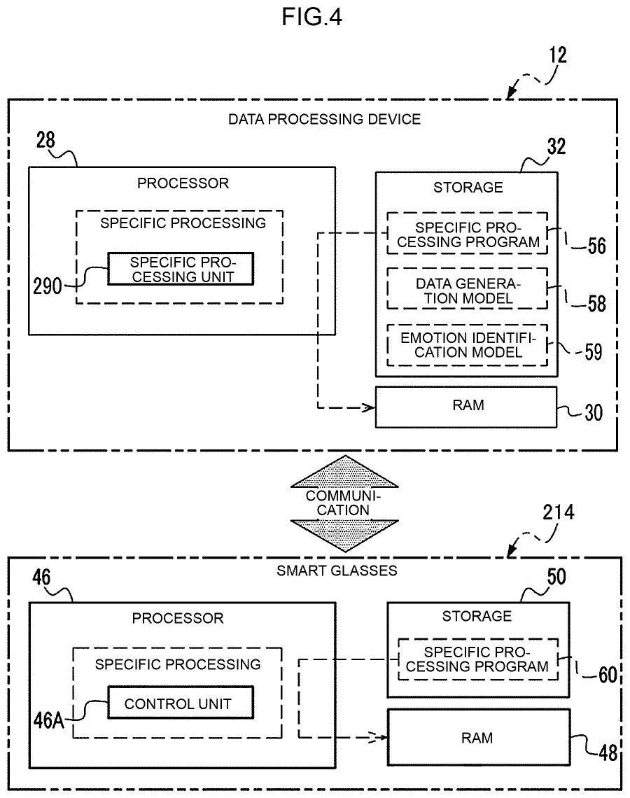

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVMV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the authentication unit, retrieval unit, monitoring unit, assist unit, selection unit, temperature control unit, blocking unit, communication unit, and display unit, is implemented, for example, in at least one of the smart glasses 214 and the data processing apparatus 12. For example, the authentication unit recognizes the user using the camera 42 or microphone 238 of the smart glasses 214 and executes the authentication process by the control unit 46A. The retrieval unit retrieves the user's learning data by the specific processing unit 290 of the data processing apparatus 12. The monitoring unit monitors the user's movements using the camera 42 of the smart glasses 214 and processes the monitoring data by the control unit 46A. The assist unit generates hints by the specific processing unit 290 of the data processing apparatus 12 and presents them through the speaker 240 of the smart glasses 214. The selection unit selects questions previously answered incorrectly and presents them again by the specific processing unit 290 of the data processing apparatus 12. The temperature control unit performs automatic temperature adjustment by the control unit 46A of the smart glasses 214. The blocking unit blocks external radio waves using the shielding technology of the smart glasses 214. The communication unit provides Wi-Fi using the communication I/F 44 of the smart glasses 214. The display unit displays information using the display of the smart glasses 214. The correspondence between each unit and the device or control unit is not limited to the above examples and various modifications are possible.

### Third Embodiment

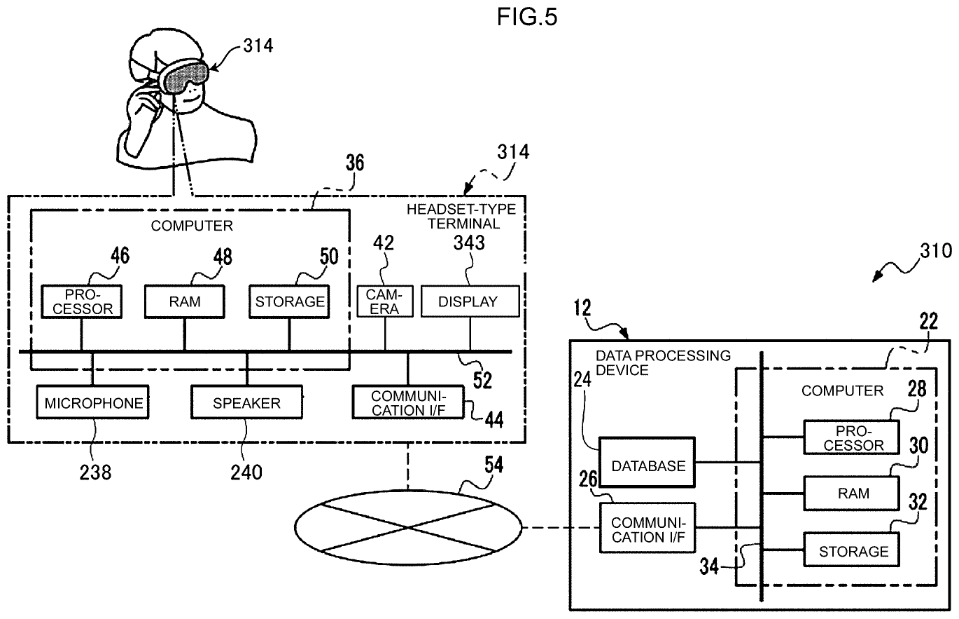

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

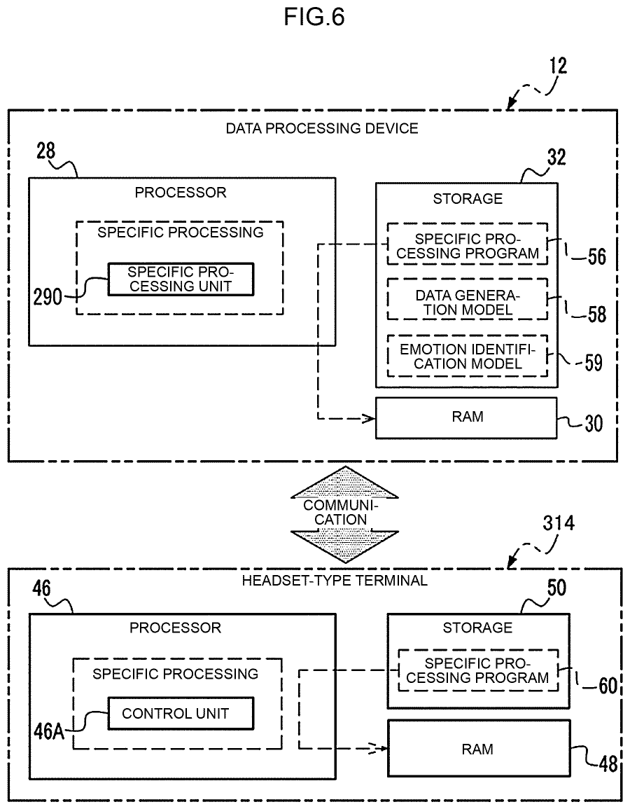

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVMV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the authentication unit, retrieval unit, monitoring unit, assist unit, selection unit, temperature control unit, blocking unit, communication unit, and display unit, is implemented, for example, in at least one of the headset-type terminal 314 and the data processing apparatus 12. For example, the authentication unit recognizes the user using the camera 42 or microphone 238 of the headset-type terminal 314 and executes the authentication process by the control unit 46A. The retrieval unit retrieves the user's learning data by the specific processing unit 290 of the data processing apparatus 12. The monitoring unit monitors the user's movements using the camera 42 of the headset-type terminal 314 and processes the monitoring data by the control unit 46A. The assist unit generates hints by the specific processing unit 290 of the data processing apparatus 12 and presents them through the speaker 240 of the headset-type terminal 314. The selection unit selects questions previously answered incorrectly and presents them again by the specific processing unit 290 of the data processing apparatus 12. The temperature control unit performs automatic temperature adjustment by the control unit 46A of the headset-type terminal 314. The blocking unit blocks external radio waves using the shielding technology of the headset-type terminal 314. The communication unit provides Wi-Fi using the communication I/F 44 of the headset-type terminal 314. The display unit displays information using the display 343 of the headset-type terminal 314. The correspondence between each unit and the device or control unit is not limited to the above examples and various modifications are possible.

### Fourth Embodiment

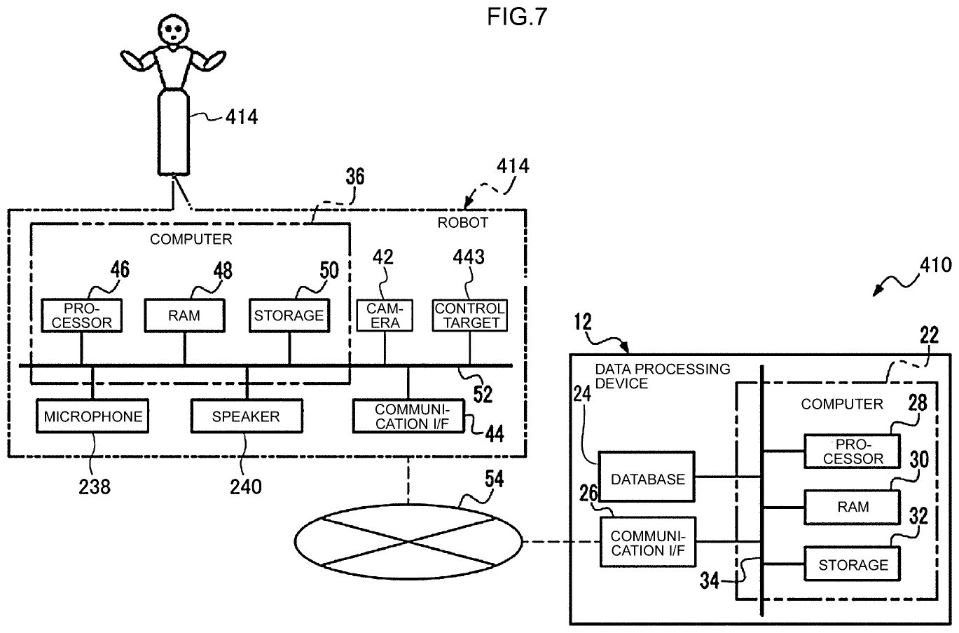

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

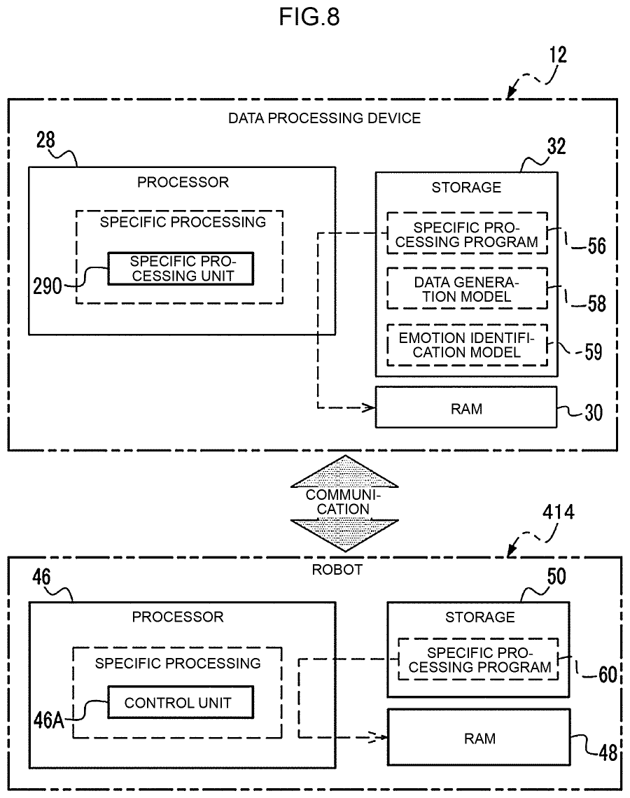

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVMV), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the authentication unit, retrieval unit, monitoring unit, assist unit, selection unit, temperature control unit, blocking unit, communication unit, and display unit, is implemented, for example, in at least one of the robot 414 and the data processing apparatus 12. For example, the authentication unit recognizes the user using the camera 42 or microphone 238 of the robot 414 and executes the authentication process by the control unit 46A. The retrieval unit retrieves the user's learning data by the specific processing unit 290 of the data processing apparatus 12. The monitoring unit monitors the user's movements using the camera 42 of the robot 414 and processes the monitoring data by the control unit 46A. The assist unit generates hints by the specific processing unit 290 of the data processing apparatus 12 and presents them through the speaker 240 of the robot 414. The selection unit selects questions previously answered incorrectly and presents them again by the specific processing unit 290 of the data processing apparatus 12. The temperature control unit performs automatic temperature adjustment by the control unit 46A of the robot 414. The blocking unit blocks external radio waves using the shielding technology of the robot 414. The communication unit provides Wi-Fi using the communication I/F 44 of the robot 414. The display unit displays information using the display of the robot 414. The correspondence between each unit and the device or control unit is not limited to the above examples and various modifications are possible.

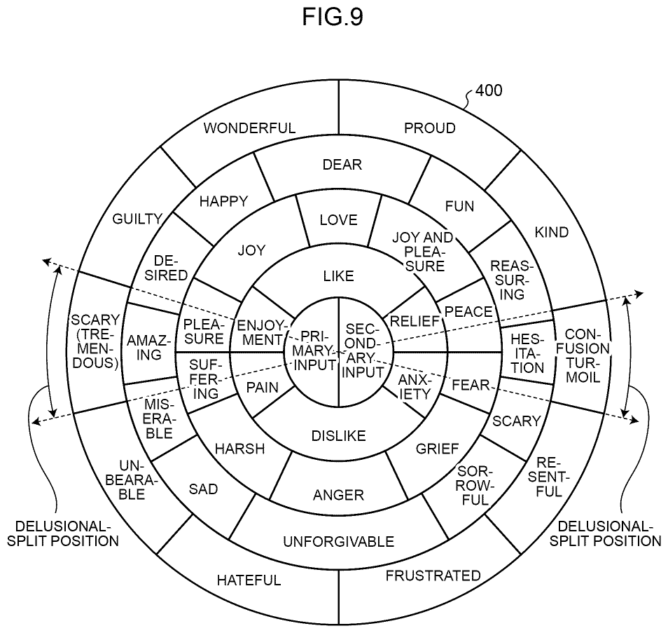

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

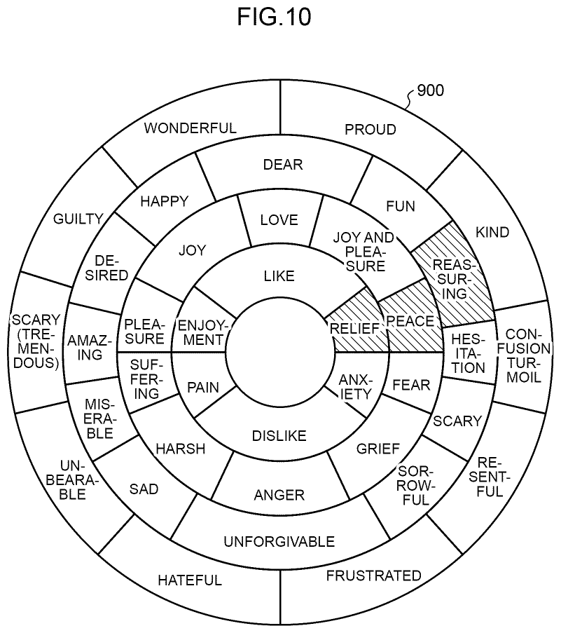

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### [Additional Note 1]

A system comprising: an authentication unit that recognizes a user; a retrieval unit that retrieves learning data of the user recognized by the authentication unit; a monitoring unit that monitors the user's movements; an assist unit that provides hints when the movement monitored by the monitoring unit stops; a selection unit that selects questions previously answered incorrectly and presents them again; a temperature control unit that performs automatic temperature adjustment by AI; a blocking unit that blocks external radio waves; a communication unit that provides Wi-Fi; and a display unit that displays information on a monitor.

### [Additional Note 2]

The system according to Additional Note 1, wherein the monitoring unit monitors the user's movements in real time.

### [Additional Note 3]

The system according to Additional Note 1, wherein the assist unit provides a hint after a predetermined period of time when the user's movement stops.

### [Additional Note 4]

The system according to Additional Note 1, wherein the selection unit selects questions previously answered incorrectly and presents them again.

### [Additional Note 5]

The system according to Additional Note 1, wherein the temperature control unit performs automatic temperature adjustment by AI.

### [Additional Note 6]

The system according to Additional Note 1, wherein the blocking unit blocks external radio waves.

### [Additional Note 7]

The system according to Additional Note 1, wherein the communication unit provides Wi-Fi.

### [Additional Note 8]

The system according to Additional Note 1, wherein the display unit displays information on a monitor.

### [Additional Note 9]

The system according to Additional Note 1, wherein the authentication unit estimates the user's emotion and adjusts the speed of the authentication process based on the estimated emotion.

### [Additional Note 10]

The system according to Additional Note 1, wherein the authentication unit refers to the user's past authentication history at the time of authentication to improve authentication accuracy.

### [Additional Note 11]

The system according to Additional Note 1, wherein the authentication unit additionally acquires the user's biometric information at the time of authentication to enhance the reliability of authentication.

### [Additional Note 12]

The system according to Additional Note 1, wherein the authentication unit estimates the user's emotion and selects an authentication method based on the estimated emotion.

### [Additional Note 13]

The system according to Additional Note 1, wherein the authentication unit customizes the authentication process by taking into account the user's geographic location information at the time of authentication.

### [Additional Note 14]

The system according to Additional Note 1, wherein the authentication unit analyzes the user's social media activity at the time of authentication to improve the reliability of authentication.

### [Additional Note 15]

The system according to Additional Note 1, wherein the retrieval unit estimates the user's emotion and adjusts the order of retrieving learning data based on the estimated emotion.

### [Additional Note 16]

The system according to Additional Note 1, wherein the retrieval unit refers to the user's past learning history at the time of retrieval to select optimal learning data.

### [Additional Note 17]

The system according to Additional Note 1, wherein the retrieval unit customizes data based on the user's current learning progress at the time of retrieval.

### [Additional Note 18]

The system according to Additional Note 1, wherein the retrieval unit estimates the user's emotion and adjusts the display method of learning data based on the estimated emotion.

### [Additional Note 19]

The system according to Additional Note 1, wherein the retrieval unit prioritizes the retrieval of highly relevant learning data by taking into account the user's geographic location information at the time of retrieval.

### [Additional Note 20]

The system according to Additional Note 1, wherein the retrieval unit analyzes the user's social media activity at the time of retrieval to retrieve relevant learning data.

### [Additional Note 21]

The system according to Additional Note 1, wherein the monitoring unit estimates the user's emotion and adjusts the monitoring frequency based on the estimated emotion.

### [Additional Note 22]

The system according to Additional Note 1, wherein the monitoring unit refers to the user's past behavior patterns at the time of monitoring to improve monitoring accuracy.

### [Additional Note 23]

The system according to Additional Note 1, wherein the monitoring unit additionally acquires the user's biometric information at the time of monitoring to enhance the reliability of monitoring.

### [Additional Note 24]

The system according to Additional Note 1, wherein the monitoring unit estimates the user's emotion and adjusts the display method of monitoring results based on the estimated emotion.

### [Additional Note 25]

The system according to Additional Note 1, wherein the monitoring unit customizes the monitoring range by taking into account the user's geographic location information at the time of monitoring.

### [Additional Note 26]

The system according to Additional Note 1, wherein the monitoring unit analyzes the user's social media activity at the time of monitoring to improve monitoring accuracy.

### [Additional Note 27]

The system according to Additional Note 1, wherein the assist unit estimates the user's emotion and adjusts the way hints are provided based on the estimated emotion.

### [Additional Note 28]

The system according to Additional Note 1, wherein the assist unit refers to the user's past learning history at the time of assistance to provide optimal hints.

### [Additional Note 29]

The system according to Additional Note 1, wherein the assist unit customizes hints based on the user's current learning progress at the time of assistance.

### [Additional Note 30]

The system according to Additional Note 1, wherein the assist unit estimates the user's emotion and adjusts the display method of hints based on the estimated emotion.

### [Additional Note 31]

The system according to Additional Note 1, wherein the assist unit prioritizes the provision of highly relevant hints by taking into account the user's geographic location information at the time of assistance.

### [Additional Note 32]

The system according to Additional Note 1, wherein the assist unit analyzes the user's social media activity at the time of assistance to provide relevant hints.

### [Additional Note 33]

The system according to Additional Note 1, wherein the selection unit estimates the user's emotion and adjusts the timing of re-presentation based on the estimated emotion.

### [Additional Note 34]

The system according to Additional Note 1, wherein the selection unit refers to the user's past learning history at the time of selection to select optimal questions.

### [Additional Note 35]

The system according to Additional Note 1, wherein the selection unit customizes questions based on the user's current learning progress at the time of selection.

### [Additional Note 36]

The system according to Additional Note 1, wherein the selection unit estimates the user's emotion and adjusts the display method of re-presentation based on the estimated emotion.

### [Additional Note 37]

The system according to Additional Note 1, wherein the selection unit prioritizes the selection of highly relevant questions by taking into account the user's geographic location information at the time of selection.

### [Additional Note 38]

The system according to Additional Note 1, wherein the selection unit analyzes the user's social media activity at the time of selection to select relevant questions.

### [Additional Note 39]

The system according to Additional Note 1, wherein the temperature control unit estimates the user's emotion and adjusts the frequency of temperature adjustment based on the estimated emotion.

### [Additional Note 40]

The system according to Additional Note 1, wherein the temperature control unit refers to the user's past temperature setting history at the time of temperature adjustment to set the optimal temperature.

### [Additional Note 41]

The system according to Additional Note 1, wherein the temperature control unit additionally acquires the user's biometric information at the time of temperature adjustment to enhance the reliability of temperature control.

### [Additional Note 42]

The system according to Additional Note 1, wherein the temperature control unit estimates the user's emotion and selects a temperature adjustment method based on the estimated emotion.

### [Additional Note 43]

The system according to Additional Note 1, wherein the temperature control unit sets the optimal temperature by taking into account the user's geographic location information at the time of temperature adjustment.

### [Additional Note 44]

The system according to Additional Note 1, wherein the temperature control unit analyzes the user's social media activity at the time of temperature adjustment to provide relevant temperature settings.

### [Additional Note 45]

The system according to Additional Note 1, wherein the blocking unit estimates the user's emotion and adjusts the timing of radio wave blocking based on the estimated emotion.

### [Additional Note 46]

The system according to Additional Note 1, wherein the blocking unit refers to the user's past blocking history at the time of blocking to select the optimal blocking method.

### [Additional Note 47]

The system according to Additional Note 1, wherein the blocking unit estimates the user's emotion and selects a blocking method based on the estimated emotion.

### [Additional Note 48]

The system according to Additional Note 1, wherein the blocking unit selects the optimal blocking method by taking into account the user's geographic location information at the time of blocking.

### [Additional Note 49]

The system according to Additional Note 1, wherein the communication unit estimates the user's emotion and adjusts the Wi-Fi connection speed based on the estimated emotion.

### [Additional Note 50]

The system according to Additional Note 1, wherein the communication unit refers to the user's past communication history at the time of communication to select the optimal connection method.

### [Additional Note 51]

The system according to Additional Note 1, wherein the communication unit estimates the user's emotion and selects a Wi-Fi connection method based on the estimated emotion.

### [Additional Note 52]

The system according to Additional Note 1, wherein the communication unit selects the optimal connection method by taking into account the user's geographic location information at the time of communication.

### [Additional Note 53]

The system according to Additional Note 1, wherein the display unit estimates the user's emotion and adjusts the display content based on the estimated emotion.

### [Additional Note 54]

The system according to Additional Note 1, wherein the display unit refers to the user's past display history at the time of display to select the optimal display method.

### [Additional Note 55]

The system according to Additional Note 1, wherein the display unit estimates the user's emotion and selects a display method based on the estimated emotion.

### [Additional Note 56]

The system according to Additional Note 1, wherein the display unit selects the optimal display method by taking into account the user's geographic location information at the time of display.

What is claimed is:

1. A system comprising: an authentication unit that recognizes a user; a retrieval unit that retrieves learning data of the user recognized by the authentication unit; a monitoring unit that monitors the user's movements; an assist unit that provides hints when the movement monitored by the monitoring unit stops; a selection unit that selects questions previously answered incorrectly and presents them again; a temperature control unit that performs automatic temperature adjustment by AI; a blocking unit that blocks external radio waves; a communication unit that provides Wi-Fi; and a display unit that displays information on a monitor.

2. The system according to claim 1, wherein the monitoring unit monitors the user's movements in real time.

3. The system according to claim 1, wherein the assist unit provides a hint after a predetermined period of time when the user's movement stops.

4. The system according to claim 1, wherein the selection unit selects questions previously answered incorrectly and presents them again.

5. The system according to claim 1, wherein the temperature control unit performs automatic temperature adjustment by AI.

6. The system according to claim 1, wherein the blocking unit blocks external radio waves.

7. The system according to claim 1, wherein the communication unit provides Wi-Fi.

8. The system according to claim 1, wherein the display unit displays information on a monitor.
